(19) United States
(12) Patent Application Publication
(10) Pub. No.: US 2008/0191080 A1
(43) Pub. Date: Aug. 14, 2008

(54) Fishing line spool support and kit

(75) Inventor: William A. Shalosky, Clyde, NC (US)

Correspondence Address: Charles F. Meroni, Jr., P.O. Box 309, Barrington, IL, 60011, US

(73) Assignee: Ian Touchstone

(21) Appl. No.: 11/706,792

(22) Filed: Feb. 14, 2007

(51) Int. Cl. A01K 89/00

(52) U.S. Cl. 242/323; 242/322

(57) ABSTRACT

A fishing line spool support and kit incorporating same enables users thereof to transfer line from a spool assembly to a reel assembly. The spool support comprises a single thin rod angled or bent at points intermediate its length to effect a plurality of rod portions, which rod portions extend in three structural planes. The rod portions define a spool-bearing portion and first and second anchor-enabling portions. The first and second anchor-enabling portions are cooperable with peripheral or external support structures such as doors and/or tackle boxes for restricting displacement of the spool support toward the spool-bearing portion as line is unwound from a rotatably received spool assembly.

### BACKGROUND OF THE INVENTION

1. Field of the Invention

The present invention generally relates to the art of spool support structures. More particularly, the present invention relates to the art of a fishing line spool support structure for enabling users thereof to transfer fishing line from a fishing line spool assembly as a line source to a fishing line reel as a line destination.

2. Description of the Prior Art

The sport of fishing is ancient. As is well known to the fishing enthusiast, fishing line in a rod and reel assembly is often lost in various lengths over time and usage. The line or the reel must therefore be replaced on occasion. Fishing line, however, is typically modestly priced as compared to reel assemblies and thus is often sold wound around line replacement spool assemblies. The line, however, must be transferred form the spool assembly to the reel assembly, which, without the aid of spool support means, is often cumbersome. Further, as noted in U.S. Pat. No. 5,839,687 ('687 patent), which issued to Magnafici et al., improper fishing line transfer can cause the line to twist. Twisted line inhibits the fishing operation by, among other things, reducing the ability to cast. A number of devices have been developed as a means to aid the fishing enthusiast to more easily and properly transfer line from a spool assembly to a reel assembly. Some of the more pertinent prior art relating to this subject is set forth in more detail hereinafter.

U.S. Pat. No. 4,948,059 ('059 patent), which issued to Lewitt, discloses a Tensioning Device for a Fishing Line. The '09 patent teaches a tensioning device for a fishing line comprising a base member secured to a stationary structure. The base member has two outwardly extending arms, one of which is adjustable toward and away from the other. A take off spool of bulk fishing line is rotatably supported between the arms of the base member. Resistance to the take off spool is applied during rotation to keep the fishing line under tension when transferred onto a fishing reel by one person.

U.S. Pat. No. 4,958,784 ('784 patent), which issued to Totten, discloses a Collapsible Spool Holder for Fishing Line. The '784 patent teaches a collapsible spool holder comprising a base plate, two pivot arms, and two pins to hold the arms on the sides of the base plate and a shaft that snaps into the pivot arms. It is used to hold fishing line spools so as a person can replenish the fishing line on the reel of their poles. First one screws the base plate onto a hard, smooth surface (tackle box, boat, etc.), then the shaft is snapped out of the pivot arms. Next the shaft is inserted into the middle of the spool and snapped back into the slots of pivot arms. The product stays stationary so as one could unwind the fishing line from the spool which rotates with its flanges in contact with the relieved radius or shallow concave groove upon pivoting of the arms under gravity influence onto the reel of one's fishing pole.

The '687 patent discloses certain Means and Method for Transferring Fishing Line from a Storage Spool to a Fishing Reel on a Fishing Rod. The '687 patent teaches a one-piece hanger element comprising a central section which rotatably supports a spool of fishing line and has a shoulder that engages a fishing rod to releasably support the spool of fishing line on the rod while fishing line is fed from the spool to the reel to load that reel. Arms on the hanger element prevent the spool from falling off the central section, and one of the arms is spreadable to adjust the tension on the fishing line as it is fed from the spool to the reel. The hanger element can be sold with the spool as a unit.

U.S. Pat. No. 6,742,737 ('737 patent), which issued to Connor, discloses a Fishing Line Feeder Spool Support. The '737 patent teaches a fishing line feeder spool support comprising a pair of flexible arms which are adapted to grip a fishing rod ahead of a fishing reel mounted thereon. The feeder spool support comprises a threaded shaft which rotatably supports a spool of fishing line while the fishing line is installed onto the fishing reel through the operation of the reel crank. A flanged nut is threaded onto the shaft to hold the spool. The line tension can be adjusted by tightening the flanged nut against the spool, thereby adjusting the pulling force needed to remove line from the supply spool. A crankable supply spool can also be installed on the shaft to remove and store fishing line from the fishing reel for later replacement on the reel.

From a review of these publications and other prior art generally known in the relevant art, it will be seen that the prior art does not teach a spool support having elastically deformable appendages for retaining the spool assembly in place during line transfer, and which spool support may further comprise an elastically deformable Z-shaped plane configuration for enhancing anchored engagement with peripheral or external support or anchoring structure(s). The prior art thus perceives a need for a spool support having elastically deformable spool-bearing portions for rotatably receiving and supporting a spool assembly, which spool support may further comprise Z-shaped plane configuration(s) for enhancing anchored engagement with external support structure.

### SUMMARY OF THE INVENTION

Accordingly, it is an object of the present invention to provide certain novel means for effectively transferring fishing line from a spool assembly to a reel assembly. It is another object of the present invention to provide certain means for transferring fishing line from a spool assembly to a reel assembly which means and spool assembly can be provided as a packaged kit. To achieve these and other readily apparent objectives, the present invention essentially discloses a fishing line spool support for enabling a user to rotatably anchor a fishing line spool assembly for transferring line therefrom

The spool support comprises a single thin rod bent or angled at a plurality of points intermediate its length to effect a three-dimensional structure, the three-dimensional structure comprising ten substantially linear rod portions and three structural planes. Four of the rod portions are orientable in a first structural plane, four of the rod portions are orientable in a second structural plane, and two of the rod portions are orientable in a third structural plane.

The first and second structural planes are preferably parallel when in relaxed state, and the third structural plane intersects the first and second structural planes such that the structure may be defined by a Z-shaped plane configuration. Two of the rod portions orientable in the first structural plane are elastically deformable for extending through a fishing line spool assembly and enabling spool assembly rotation thereabout. The second and third structural planes may function to couple with or otherwise cooperate with external support structure such as chairs, doors, or tackle boxes.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is a top perspective view of the spool support of the present invention showing spool-bearing first and tenth rod portions in a coextensive configuration.

FIG. 2 is a first bottom perspective view of the spool support of the present invention showing spool-bearing first and tenth rod portions in a crisscrossed configuration.

FIG. 3 is a second bottom perspective view of the spool support of the present invention showing spool-bearing first and tenth rod portions in a crisscrossed configuration rotatably receiving a spool assembly.

FIG. 4 is a top perspective view of the spool support of the present invention showing spool-bearing first and tenth rod portions in a crisscrossed configuration rotatably receiving a spool assembly and anchored to a fragmentary door-doorknob assembly.

FIG. 5 is a bottom perspective view of the spool support of the present invention rotatably receiving a spool assembly and anchored to a chair assembly.

FIG. 6 is a top plan view of the spool support of the present invention showing spool-bearing first and tenth rod portions in a crisscrossed configuration rotatably receiving a spool assembly and anchored to a fragmentary tackle box assembly.

FIG. 7 is a top plan view of the spool support of the present invention showing spool-bearing first and tenth rod portions in a crisscrossed configuration.

FIG. 8 is a side plan view of the spool support of the present invention in a fully relaxed state and showing spool-bearing first and tenth rod portions in a crisscrossed configuration.

FIG. 9 is a side plan view of the spool support of the present invention in a partially stressed state adjacent a fragmentary door-doorknob assembly and showing spool-bearing first and tenth rod portions in a crisscrossed configuration.

FIG. 10 is a side plan view of the spool support of the present invention in a partially stressed state at the spool-bearing first and tenth rod portions in crisscrossed configuration.

FIG. 11 is a bottom perspective view of an alternative embodiment of the spool support of the present invention showing second and ninth rod portions in an manually and elastically deformed position for enabling spool assembly installation about the first and tenth rod portions.

FIG. 12 is a perspective view of a first spool assembly having a first depth and a first diameter and usable in combination with the spool support of the present invention.

FIG. 13 is a perspective view of a second spool assembly having a second depth and a second diameter usable in combination with the spool support of the present invention

FIG. 14 is a top perspective view of a line-transferring kit of the present invention showing a packaged spool support and spool assembly.

FIG. 15 is a top perspective view of the spool support of the present invention showing spool-bearing first and tenth rod portions in a coextensive configuration and situated upon a right-handed Cartesian coordinate system.

FIG. 16 is a side plan view of the spool support of the present invention in a fully relaxed state situated upon a right-handed Cartesian coordinate system.

### DETAILED DESCRIPTION OF THE PREFERRED EMBODIMENT(S)

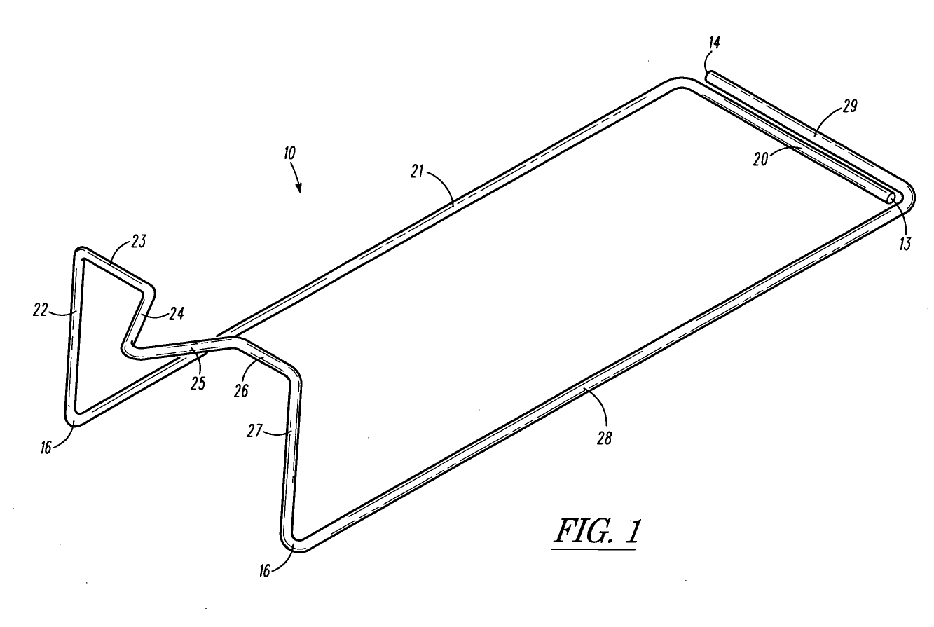

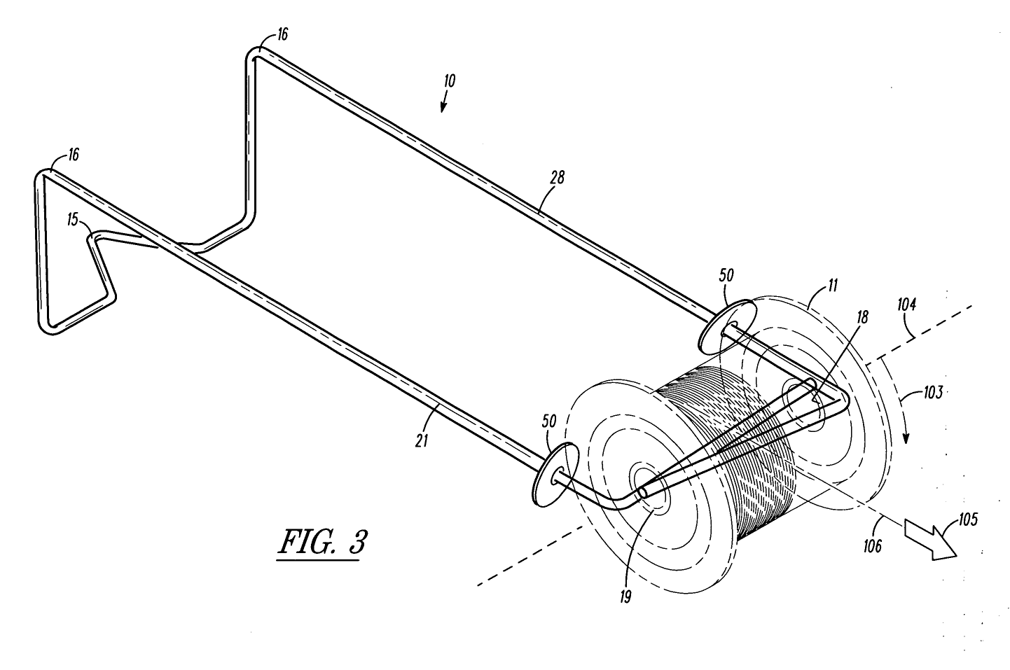

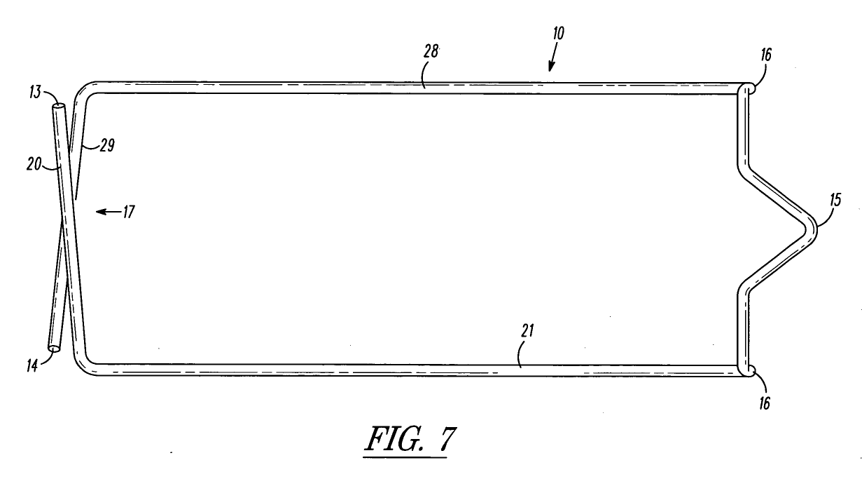

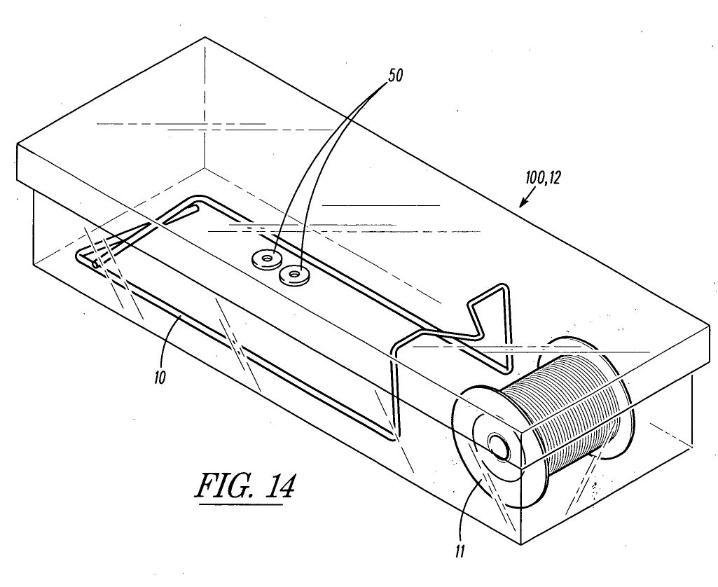

Referring now to the drawings with more specificity, the preferred embodiment of the present invention generally concerns a fishing line spool support 10 as generally illustrated and referenced in FIGS. 1-11 and 14-16. The fishing line spool support 10 is designed for use in combination with a fishing line spool assembly 11 as illustrated and referenced in FIGS. 3-6 and 10-14. Bearing these notions in mind, it is further contemplated that the essential teachings of the present invention may be said to disclose a line-transferring kit 12 incorporating the spool support 10 and spool assembly 11 as generally depicted and referenced in FIG. 14. It will be seen from an inspection of FIG. 14 that the kit 12 may be supplied to end users in packaged form as at 100.

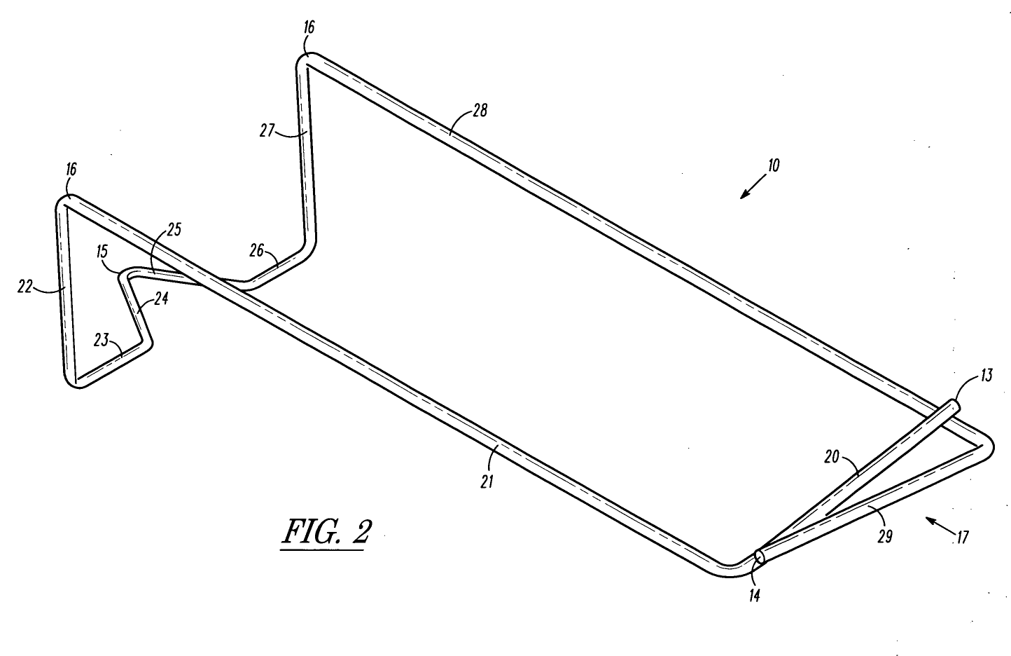

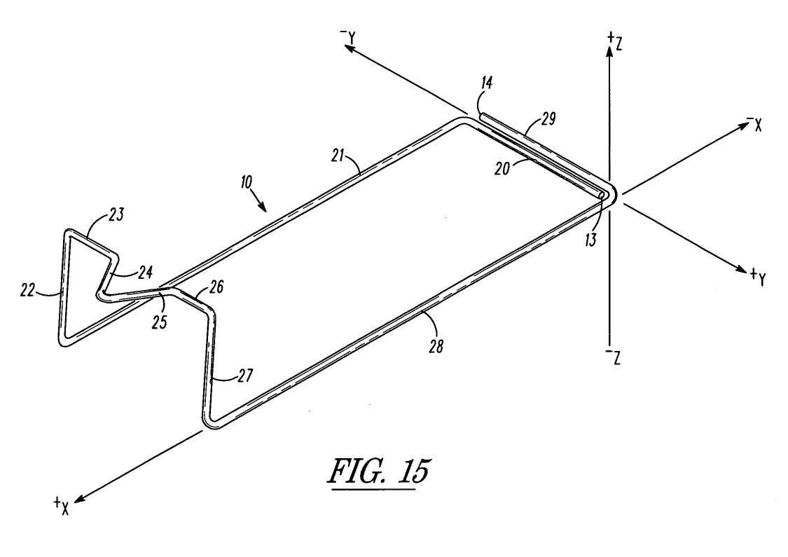

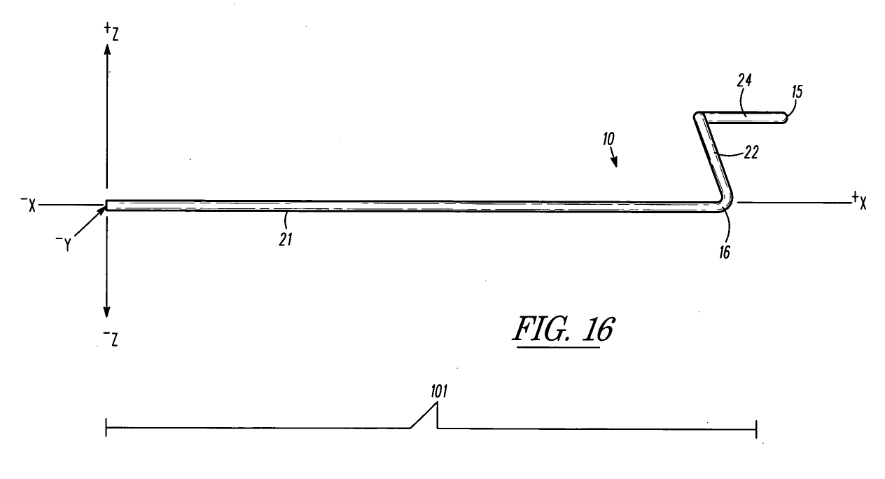

The spool support 10 preferably comprises a single thin rod, the rod being definable in three dimensions according to a right-handed Cartesian coordinate system (having an X-axis, a Y-axis, and a Z-axis) as generally depicted in FIGS. 15 and 16, and as comparatively referenced in FIGS. 1 and 2. Noting that the rod extends intermediate its first end 13 and its second end 14, the first end 13 of the spool support 10 may be placed at the origin of the coordinate system, the structure of the support 10 may be traced as follows: A first lateral half of the support comprises a first rod portion 20 extending in the negative Y-direction along the Y-axis a first distance. The support 10 further comprises a second rod portion 21 (bent at a substantially 90° angle relative to the first rod portion 20) extending in the positive X-direction (in the X-Y plane) a second distance. The support 10 further comprises a third rod portion 22 (bent at about 70° angle relative to the second rod portion 21) extending in the negative X and positive Z directions (parallel to the X-Z plane) a third distance. The support 10 further comprises a fourth rod portion 23 (bent at a substantially 90° angle relative to the third rod portion 22) extending in the positive Y direction (parallel to the Y-axis) a fourth distance. The support 10 further comprises a fifth rod portion 24 (bent at about a 45° angle relative to the fourth rod portion 23) in the positive Y and positive X directions (parallel to the X-Y plane) a fifth distance.

It is contemplated that the first lateral half distances may thus be ranked from least to greatest according to the following ranking: fourth distance<fifth distance<third distance<first distance<second distance. Extending a mirror image plane parallel to the second rod portion 21 through the end of the fifth rod portion 24 and perpendicular to the X-Y plane, a second lateral half of the support further comprises mirror image rod portions about the mirror image plane. Thus, the second lateral half of the support may comprise a sixth rod portion 25 akin to the fifth rod portion 24, a seventh rod portion 26 akin to the fourth rod portion 23, an eighth rod portion 27 akin to the third rod portion 22, a ninth rod portion 28 akin to the second rod portion 21, and a tenth rod portion 29 akin to the first rod portion 20.

Notably, the tenth rod portion 29 would thus be coaxial to the first rod portion 20 as set forth by the foregoing. Since structure cannot overlap, the tenth rod portion 29 may preferably extend parallel to or coextensive with the first rod portion 20 and thus the ninth rod portion 28 is preferably infinitesimally lesser in magnitude than the second rod portion 21 or vice versa. Alternatively, the second and ninth distances may remain substantially equal in magnitude, with the first rod portion 20 and the tenth rod portion 29 being coplanar in the Y-Z plane. Given the latter structural configuration, the second and ninth rod portions 21 and 28 would not be exactly planar (not specifically illustrated).

The following dimensions exemplify each of the preferred rod portions, it being noted that the rod is preferably formed from 0.125-inch (or ⅛ inch or 0.492 mm) (metallic) load-bearing, malleable stock. The first and tenth rod portions 20 and 29 are preferably on the order of about 3.125 inches (or 7.938 cm) in length; the second and ninth rod portions 21 and 28 are preferably on the order of about 6.875 inches (or 17.46 cm) in length; the third and eighth rod portions 22 and 27 are preferably on the order of about 1.875 inches (or 4.763 cm) in length; the fourth and seventh rod portions 23 and 26 are preferably on the order of about 0.75 inches (1.905 cm) in length; and the fifth and sixth rod portions 24 and 25 are preferably on the order of about 1.15 inches (2.921 cm) in length.

It may be seen from an inspection of FIGS. 1 and 15 that the first, second, ninth, and tenth rod portions 20, 21, 28, and 29 may be preferably coplanar (or substantially coplanar) in a first structural plane (i.e. the X-Y plane); the third and eighth rod portions 22 and 27 may be preferably coplanar in a second structural plane angled at about 70° to the first structural plane; and the fourth, fifth, sixth, and seventh rod portions 23, 24, 25, and 26 may be preferably coplanar in a third structural plane angled at about 70° relative to the second structural plane and parallel to the first structural plane as further generally depicted in FIGS. 1 and 15.

The first, second, ninth, and tenth rod portions 20, 21, 28, and 29 substantially define a three-sided (or open sided) rectangle; the third and eight portions 22 and 27 extend parallel to one another in a third dimension from the open side of the three-sided rectangle; the fourth and seventh rod portions 23 and 26 define coaxial, triangular-point-positioning structure; and the fifth and sixth rod portions 24 and 25 define a two-sided (or open-sided) triangle portion or pointed structure 15 as further illustrated and referenced in FIGS. 1-4, 6-10, and 16.

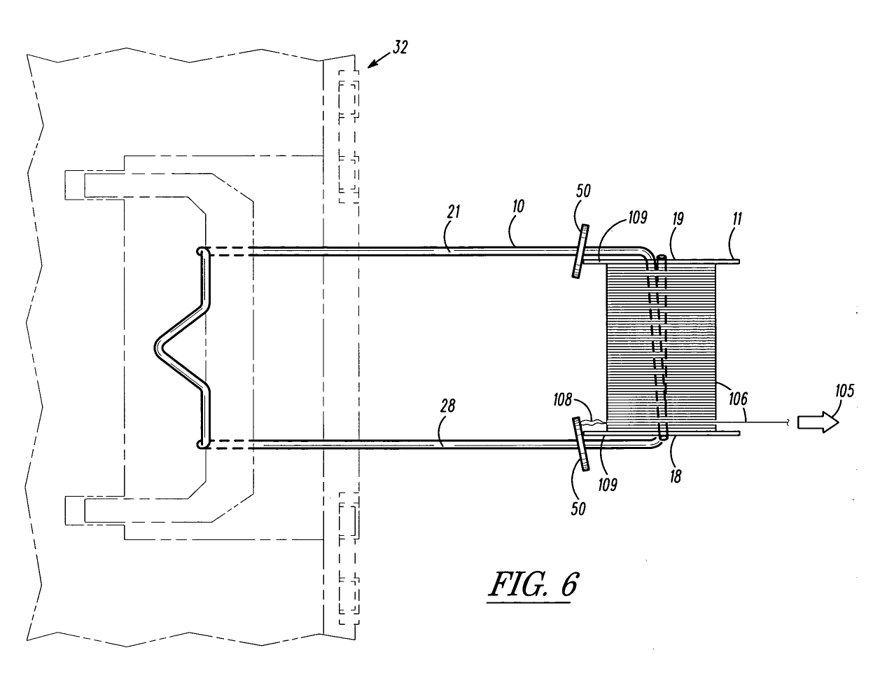

Given (1) the noted preferred angle intermediate the first and second structural planes (70°); (2) the noted preferred angle intermediate the second and third structural planes (70°); (3) the preferred dimensions of the rod portions; and the trigonometric relation: (cos θ)=(adjacent/hypotenuse); it may be understood that the end to end, relaxed longitudinal distance of the support 10 may preferably be on the order of about 7.05 inches (or 17.91 cm) in length as denoted at 101 in FIG. 16. In this regard, it will be seen that the pointed structure 15 extends in the third structural plane such that the tip thereof is a greater distance from the Y-Z plane than then the forward most ends 16 of the second and ninth rod portions 21 and 28 as perhaps most clearly depicted in FIGS. 6-10, and 16.

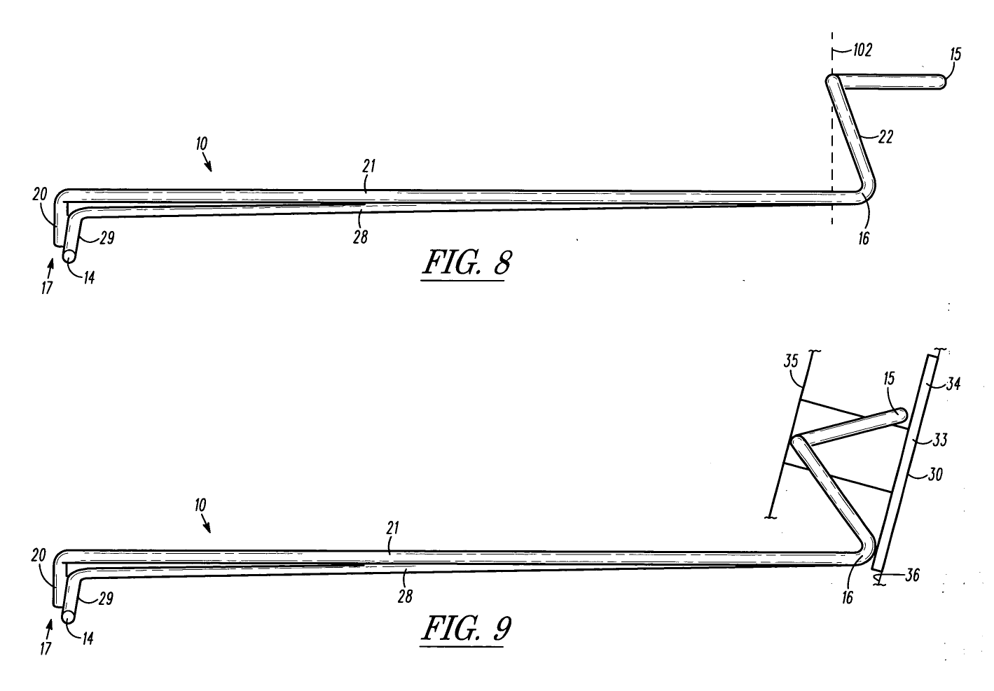

In other words, given (1) a 70° angle intermediate the first and second structural planes (and the second and third structural planes) and (2) the third and eighth rod portion dimension of about 1.875 inches, the second structural plane terminates about 0.641 inches rearward (in the negative X-direction) of ends 16 thereby yielding a first structural marker 102, which marker 102 is approximately 6.234 inches from the Y-Z plane (6.875 inches−0.641 inches=6.234 inches) as generally depicted in FIG. 8. Further, from an inspection of FIG. 8, it will be seen that the pointed structure 15 extends forward about 0.813 inches from marker 102 (1.15 inches×COS 45°=0.813 inches) thereby yielding an end-to-end relaxed length of approximately 7.05 inches as previously stated.

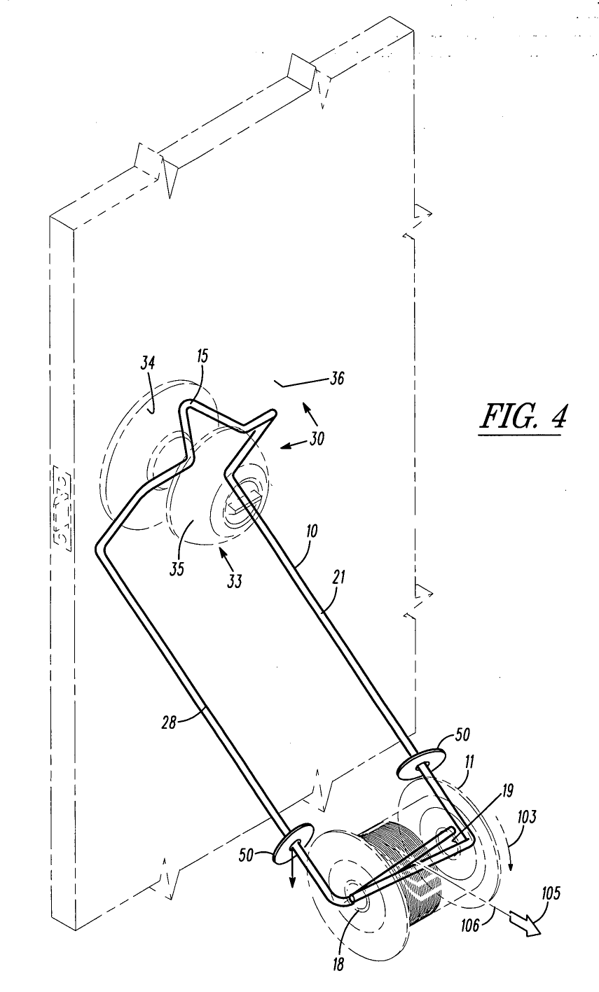

In this last regard, it should be noted that the structure is in a relaxed state when not operatively engaged. In other words, when the spool support 10 is operatively engaged, certain structures are preferably elastically deformed such that after a deforming force is removed, the structure may return to its relaxed equilibrium state. In this regard, the reader is further directed to FIGS. 8, 9, and 4-6, 8, and 9 wherein it will be seen that certain rod portions may be elastically displaced when operatively engaged.

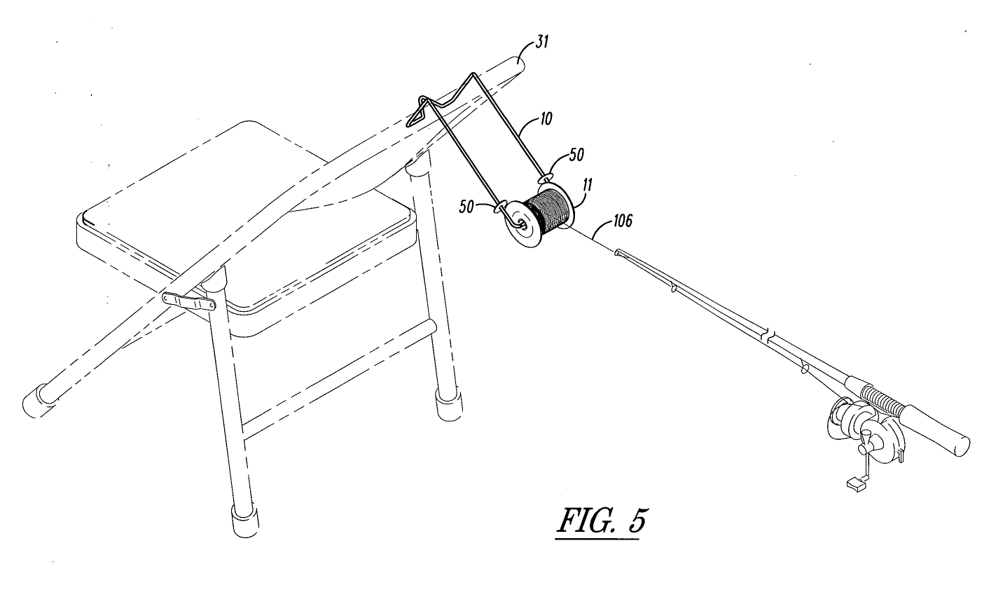

More particularly, it may be seen from a comparative inspection of FIGS. 8 and 9 that the relaxed angle intermediate the first and second structural planes (70°) may be elastically decremented so as to accommodate external support structure (such as a door-doorknob assembly 30 as depicted and referenced in FIGS. 4 and 9; a chair assembly 31 as depicted and referenced in FIG. 5; or a tackle box assembly 32 as depicted and referenced in FIG. 6.

It may be seen from a comparative inspection of FIGS. 4 and 9, for example, that when the spool support 10 operatively engages an external support structure such as a door knob assembly 33, the first and second structural planes may be elastically deformed from their otherwise relaxed state. In this regard, it may be seen that the doorknob assembly 33 may comprise a base portion 34, which base portion 34 is attachable to a planar door portion 35. The base portion 34, however, has a certain depth or thickness, which depth may force the pointed structure rearward thereby decrementing the angle intermediate the first and second structural planes as depicted in FIG. 9. When removed from the doorknob assembly 33, the third and eighth rod portions 22 and 27 may return to the equilibrium position as generally depicted in FIG. 8.

The spool support 10 may be operatively engaged with the doorknob assembly 30 as an external support structure. In this regard, it may be further seen that the pointed structure 15 as defined by the fifth and sixth rod portions 24 and 25 is preferably sized and shaped to extend intermediate a hand-turning knob portion 35 and the base portion 34, and the junction(s) intermediate the second and ninth rod portions 21 and 28 versus the third and eighth rod portions 22 and 27 (as at ends 16) engage the door 36 supporting the doorknob assembly 33. This engagement thus functions to help anchor the spool support 10 such that (fishing) line 106 may be unspooled or unwound from the line spool assembly 11. It is contemplated that the pointed structure 15 may well function to minimize and stabilize contact intermediate the spool support 10 and the external support structure as, for example, by providing a stable three-point contact (via pointed structure and ends 16).

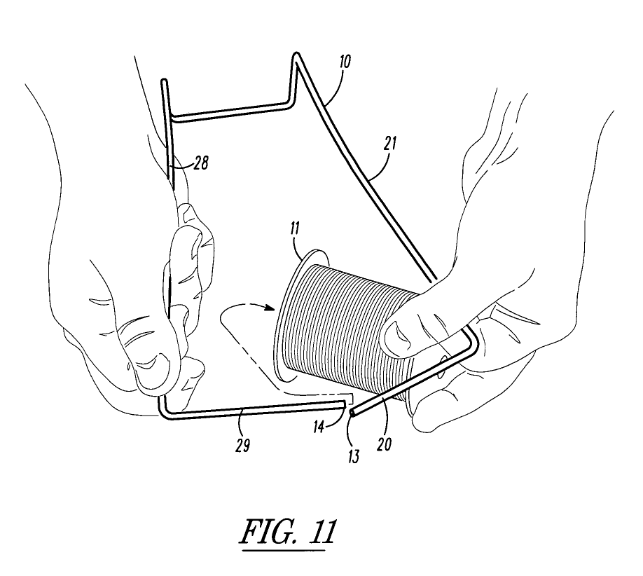

Further, it may be seen from an inspection of FIG. 11 that the second and ninth rod portions 21 and 28 may be elastically (manually) deformed so as to reposition the first and tenth rod portions 20 and 29 such that a line spool assembly 11 may be installed or rotatably received thereabout. After inserting the first and tenth rod portions 20 and 29 through the inner cylindrical diameter of the line spool assembly 11, the forces elastically deforming the second and ninth rod portions 21 and 28 may be removed and the second and ninth rod portions 21 and 28 may be returned to their relaxed equilibrium position as generally depicted in FIG. 1-4, 6, and 7. The elastically deformability of the stock material may further extend to the first and tenth rod portions 20 and 29 comprising first and second rod ends 13 and 14, which ends 13 and 14 notably terminate in opposing directions when the second and ninth rod portions 21 and 28 are in a relaxed state.

It may be further seen from an inspection of FIGS. 2, and 7-9 that the first and tenth rod portions 20 and 29 may be plastically deformed in the positive (or negative) Z-direction so as to form a X-shaped or crisscrossed structure 17. In this regard, it is contemplated that when the first and tenth rod portions 20 and 29 are inserted into the inner cylindrical diameter of the line spool assembly 11 (as generally depicted in FIGS. 3-6, 10, and 11), the first and tenth rod portions 20 and 29 may be elastically deformed so as to receive the inner cylindrical diameter and, after inserted, released so as to return toward their respective equilibrium positions.

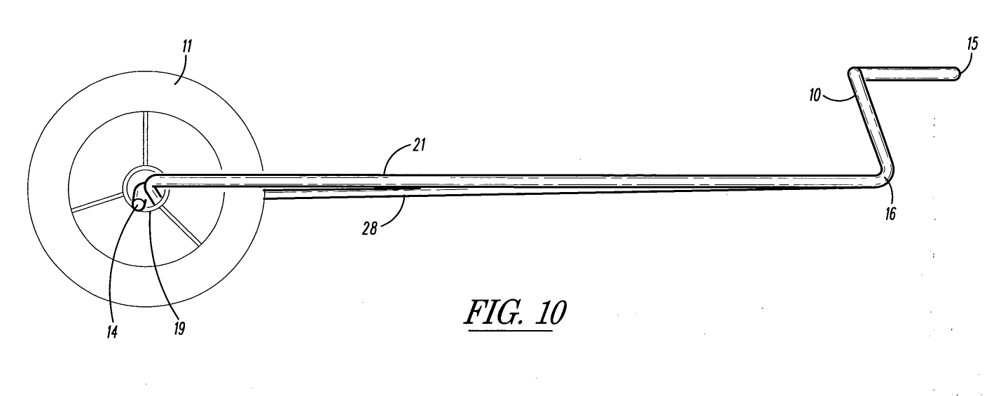

The spring constant(s) inherent in the material thus force the first and tenth rod portions 20 and 29 back toward the relaxed equilibrium position (i.e. the X-shaped or crisscrossed structure) as a means to hold the line spool assembly 11 in place via rod portion contact with the inner diameter ends and thereby substantially centering the line spool assembly 11 relative to the mirror image plane or ends 13 and 14. In this regard, the reader is directed to comparatively inspect FIGS. 8 and 9 versus FIG. 10. There it will be seen that when in the relaxed equilibrium position (as seen in FIGS. 8 and 9), the ends 13 and 14 are maximally displaced relative to the portions 21 and 28. However, when stressed or elastically deformed the displacement is decremented thereby forcing the portions 20 and 29 into contact with the inner diameter ends 18 and 19 (as further referenced in FIGS. 3, 4, and 6).

Notably, the frictional contact intermediate the first and tenth rod portions 20 and 29 and the inner diameter ends 18 and 19 is sufficient to center, direct, or retain the line spool assembly 11 in centered position relative to the ends 13 and 14, but insufficient to restrict rotation (as at 103) about the spool axis 104 provided sufficient tension 105 is placed into the line 106 unspooling or unwinding from the spool assembly 11 as depicted and referenced in FIG. 3. In other words, the line spool assembly 11 may rotate (under frictional engagement with the first and tenth rod portions 20 and 29) so that line 106 may be unspooled or unwound and transferred to a fishing reel 40 as generally depicted in FIG. 5. It is noted that the coefficient of static friction is generally larger in magnitude than the coefficient of kinetic friction and thus the (return) forces (generated from the elastically deformed first and tenth rod portions 20 and 29) enable normal forces from the inner diameter ends 18 and 19, which in combination with the coefficient(s) of friction (either static or kinetic) prevent or allow spool rotation 103 about the spool axis 104 for selectively unspooling line 106 for transfer to the reel assembly 40.

The present invention thus contemplates a fishing line spool support 10 for enabling a user to anchor a fishing line spool assembly 11 or similar other type spool assembly for transferring line otherwise wound round the spool assembly to a reel assembly 40 or similar other destination. The spool support 10 may be said to essentially comprise a single thin (malleable) rod, the thin rod being bent at a plurality of points intermediate its length to effect a three-dimensional structure. The three-dimensional structure comprises ten substantially linear rod portions (such as rod portions 20-29) and three structural planes. Four of the ten rod portions are preferably orientable in a first of the three structural planes (such as the structural plane in which rod portions 20, 21, 28, and 29 are located); four of the ten rod portions are preferably coplanar in a second of the three structural planes (such as the structural plane in which rod portions 23-26 are located); and two of the ten rod portions are preferably coplanar in a third of the three structural planes (such as the structural plane in which rod portions 22 and 27 are located).

Notably, the first and second structural planes are preferably parallel when in a relaxed plane configuration, and the third structural plane intersects the first and second structural planes at an angle thereby forming what may be referred to as a Z-shaped plane configuration. Two of the rod portions orientable in the first structural plane (i.e. the first and tenth rod portions 20 and 29) are elastically deformable for extending through the spool assembly 11 and enable spool assembly rotation (as at 103) thereabout. The third structural plane may well function to anchor the spool support 10 to external anchoring means or external support structure as may be preferably defined by a door-doorknob assembly 30, a chair assembly 31, a tackle box assembly 32, or similar other anchor-enabling support structure. The spool support 10 thus enables a user to anchor the spool assembly 11 for transferring line 106 therefrom.

The spool-bearing rod portions (i.e. the first and tenth rod portions 20 and 29) are plastically deformable into a relaxed crisscrossed position, which spool-bearing rod portions are elastically deformable from the relaxed crisscross position into a substantially parallel or coextensive, stressed rod position for rotatably receiving the spool assembly. The crisscrossed rod portions may well function to center a rotatably received spool assembly relative to the rod ends as the stressed rod position elastically returns to the relaxed crisscrossed position. Further, at least two of the rod portions in the second structural plane (i.e. the fifth and sixth rod portions 24 and 25) may form a pointed structure 15, which pointed structure 15 is preferably centered relative to the two rod portions in the third structural plane (i.e. the third and eighth rod portions 22 and 27) for enhancing cooperative association with the external anchoring means.

It will be further seen from an inspection of FIGS. 3-6, and 14 that the invention may further preferably comprise certain means for guiding line 106 (or line-guiding means) as it unwinds from the spool assembly. In this regard, it is contemplated that certain washers 50 may well second and ninth rod portions 21 and 28 by way of the open inner diameters or apertures of washers 50. Under gravitational forces, the weight (as referenced at vector arrow 51 in FIG. 4) of washers 50 function to guide (displace downwardly) the washers 50 into engagement with spool assembly 11 as perhaps most clearly depicted in FIG. 4. From a comparative inspection of FIGS. 4 and 6, it may be seen that washers 50 (or similar other means for guiding line 106 as it unwinds from spool assembly 11) engage the spool assembly and extend laterally and medially about second and ninth rod portions 21 and 28. The medially extending portions may well function to prevent slack line 108 from otherwise being entangled intermediate spool assembly 11 and ends 16. In other words, the washers 50 or similar other medially extending structure may well function to guide slack line 108 back into close radial adjacency to spool 107 or within radial extremes as defined by the flanges 109 of spool 107. Essentially, the line-guiding means function to limit the radial distance of line otherwise transferable from a spool assembly. It is thus contemplated that the line-guiding means of the present invention as may be preferably defined by washers 50 may thus function to keep the transfer of line 106 operation uninterrupted and entanglement-free.

While the above description contains much specificity, this specificity should not be construed as limitations on the scope of the invention, but rather as an exemplification of the invention. For example, the invention may be described as a spool support for enabling a user to anchor a spool assembly for transferring line from the spool assembly. The spool support may comprise a single rod angled at points intermediate its length to effect a plurality of rod portions. The rod portions may define a spool-bearing portion such as the first and tenth rod portions 20 and 29; and first and second anchor-enabling portions such as rod portions 22-27. The first and second anchor-enabling portions are preferably cooperable with external anchoring means for restricting support displacement toward the spool-bearing portion. In other words, when anchored by a door-doorknob assembly 30, a chair assembly 31, a tackle box assembly 32 or similar other external support structure, the anchor-enabling portions function to prevent displacement of the spool support toward the spool-bearing portion via the tension 105. The spool-bearing portion functions to rotatably receiving a line-wound spool assembly and the spool support enables a user to anchor a spool assembly for transferring line therefrom.

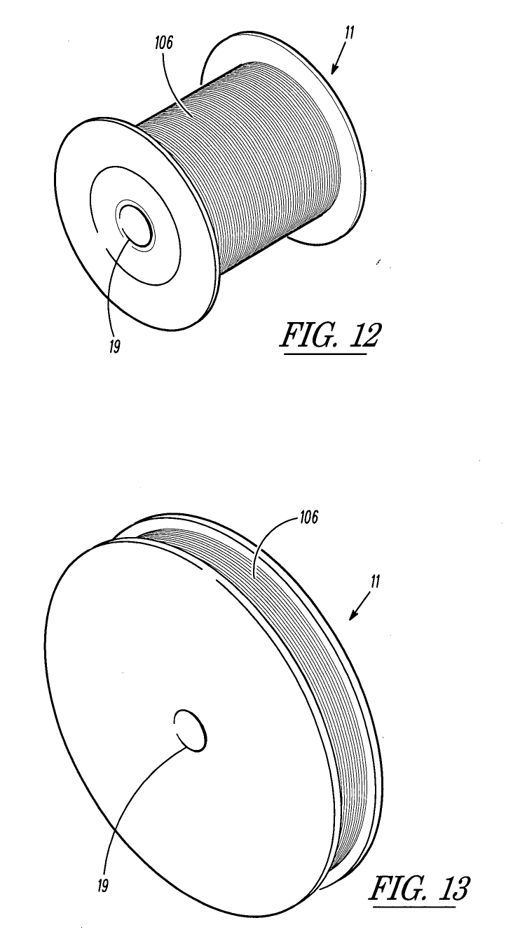

The spool support preferably further comprises a planar spool-extending portion (such as second and ninth rod portions 21 and 28) for linking the spool-bearing portion and the second anchor-enabling portion and enabling a user to extend the spool-bearing portion a substantially uniform distance from the second anchor-enabling portion. In this regard, it may be noted from a comparative inspection of FIGS. 12 versus 13 that spool assemblies may comprise various diameters and depths. It is contemplated that the exemplary dimensions earlier recited are not meant as limitations but illustrative for certain spool assembly dimensions. The dimensions may be altered to accommodate spools of varying diameters and depths.

Further, as earlier noted, it is contemplated that the present invention may be regarded as a line-transferring kit 12 for enabling a user to transfer line such as fishing line 106 from a line source such as a spool assembly 11 to a line destination such as a reel assembly 40. The line-transferring kit 12 of the present invention may be said to comprise a spool assembly 11 and a spool support 10. The spool assembly 11 comprises a spool 107 and line 106, wherein the line 106 is (frictionally) wound around the spool 107 for enabling rotation of the spool about a spool axis 104 when a tension 105 is placed on a portion of unwound line 106.

Accordingly, although the invention has been described by reference to a preferred embodiment with certain alternative renderings, and a kit incorporating the same, is not intended that the novel assembly be limited thereby, but that modifications thereof are intended to be included as falling within the broad scope and spirit of the foregoing disclosure, the following claims and the appended drawings.

I claim:

1. A fishing line spool support, the spool support for enabling a user to rotatably anchor a fishing line spool assembly for transferring line therefrom, the spool support comprising:
a single thin rod, the thin rod being bent at a plurality of points intermediate its length to effect a three-dimensional structure, the three-dimensional structure comprising ten substantially linear rod portions and three structural planes, four of the ten rod portions being orientable in a first of the three structural planes, four of the ten rod portions being orientable in a second of the three structural planes, and two of the ten rod portions being orientable in a third of the three structural planes, the first and second structural planes being parallel when in a relaxed state, the third structural plane intersecting the first and second structural planes, two of the rod portions orientable in the first structural plane being elastically deformable for extending through a fishing line spool assembly and enabling spool assembly rotation thereabout, the third structural plane for anchoring the spool support to external anchoring means, the spool support thus for enabling a user to anchor the fishing line spool assembly for transferring fishing line from the fishing line spool assembly to a reel assembly.

2. The spool support of claim 1 wherein the elastically deformable rod portions comprise first and second rod ends of the rod, the first and second rod ends terminating in opposing directions.

3. The spool support of claim 2 wherein the spool-bearing rod portions are plastically deformable into a relaxed crisscrossed position, the crisscrossed rod portion being elastically deformable into a coextensive stressed rod position for rotatably receiving the fishing line spool assembly.

4. The spool support of claim 3 wherein the crisscrossed rod portions function to center the fishing line spool assembly relative to the rod ends as the stressed rod position elastically returns to the relaxed crisscrossed position.

5. The spool support of claim 1 wherein at least two of the rod portions in the second structural plane form a pointed structure, the pointed structure being centered relative to the two rod portions in the third structural plane, the pointed structure for enhancing cooperative association with the anchoring means.

6. The spool support of claim 5 wherein the second and third structural planes are plastically deformed into a relaxed Z-shaped plane configuration relative to the first structural plane, the relaxed Z-shaped plane configuration being elastically deformable into a stressed Z-shaped plane configuration, the stressed Z-shaped plane configuration for enhancing cooperative association with the anchoring means.

7. The spool support of claim 1 comprising line-guiding means, the line-guiding means for limiting the radial distance of fishing line transferable from a fishing line spool assembly.

8. A spool support, the spool support for enabling a user to anchor a spool assembly for transferring line therefrom, the spool support comprising a single rod, the rod being angled at points intermediate its length to effect a plurality of rod portions, the rod portions defining a spool-bearing portion and first and second anchor-enabling portions, the first and second anchor-enabling portions being cooperable with external anchoring means for restricting support displacement toward the spool-bearing portion, the spool-bearing portion for rotatably receiving a line-wound spool, the spool support thus enabling a user to anchor the line-wound spool for transferring line therefrom.

9. The spool support of claim 8 wherein at least two spool-bearing rod portions define the spool-bearing portion, the spool-bearing rod portions being elastically deformable into coextensive relation for rotatably receiving the line-wound spool.

10. The spool support of claim 9 wherein the spool-bearing rod portions comprise first and second rod ends of the rod, the first and second rod ends terminating in opposing directions.

11. The spool support of claim 10 wherein the spool-bearing rod portions are plastically deformed into a relaxed crisscrossed position, the spool-bearing rod portions being elastically deformable from the relaxed crisscross position into a stressed substantially parallel position for rotatably receiving the line-wound spool.

12. The spool support of claim 11 wherein the spool-bearing rod portions function to center the line-wound spool relative to the rod ends as the spool-bearing rod portions elastically return to the relaxed crisscrossed position.

13. The spool support of claim 8 comprising a planar spool-extending portion, the spool extending portion linking the spool-bearing portion and the second anchor-enabling portion, at least two rod portions defining the spool-extending portion and enabling a user to extend the spool-bearing portion a uniform distance from the second anchor-enabling portion.

14. The spool support of claim 13 wherein the first and second anchor-enabling portions are each substantially planar and angled relative to one another, the first and second anchor-enabling portions being plastically deformed into a relaxed Z-shaped plane configuration relative to the spool-extending portion, the relaxed Z-shaped plane configuration being elastically deformable into a stressed Z-shaped plane configuration, the stressed Z-shaped plane configuration for enhancing cooperative association with the external anchoring means.

15. The spool support of claim 8 comprising line-guiding means, the line-guiding means for limiting the radial distance of line transferable from the line-wound spool.

16. A spool support, the spool support for enabling a user to rotatably anchor a line-wound spool assembly for transferring line therefrom, the spool support comprising a crisscrossed spool-bearing portion, a planar spool-extending portion, and anchoring means, the anchoring means for anchoring the spool-bearing portion to external support structure, the spool-extending portion extending intermediate the spool-bearing portion and the anchoring means for distancing the spool-bearing portion from the anchoring means, the crisscrossed spool-bearing rod portions being elastically deformable from a relaxed crisscross position into a stressed coextensive position for rotatably receiving a line-wound spool.

17. The spool support of claim 16 wherein the anchoring means are defined by first and second structural planes, the first and second structural planes and the spool-extending portion defining a Z-shaped plane configuration, the first structural plane being parallel to the spool-extending portion when in a relaxed Z-shaped plane configuration, the anchoring means being elastically deformable from the relaxed Z-shaped plane configuration for enhancing cooperative engagement with external support structure.

18. The spool support of claim 16 wherein the first structural plane comprises a pointed structure, the pointed structure for minimizing and stabilizing contact intermediate the spool support and the external support structure.

19. A line-transferring kit, the line-transferring kit for enabling a user to transfer line from a line source to a line destination, the line-transferring kit comprising:
a spool assembly, the spool assembly comprising a spool and line, the line being wound around the spool; and
a spool support, the spool support comprising a single rod, the rod being angled at points intermediate its length to effect a plurality of rod portions, the rod portions defining a spool-bearing portion and first and second anchor-enabling portions, the first and second anchor-enabling portions being cooperable with external anchoring means for restricting support displacement toward the spool-bearing portion, the spool-bearing portion for rotatably receiving the spool, the spool thus being rotatable for enabling line transfer therefrom, the line-transferring kit thus enabling a user to transfer line from the spool assembly to a line destination.

20. The line-transferring kit of claim 19 wherein at least two spool-bearing rod portions define the spool-bearing portion, the spool-bearing rod portions being orientable into substantially parallel relation and elastically deformable for rotatably receiving the spool assembly.

21. The line-transferring kit of claim 20 wherein the spool-bearing rod portions are plastically deformable into a relaxed crisscrossed position, the crisscrossed spool-bearing rod portions being elastically deformable from the relaxed crisscross position into a stressed coextensive rod position for rotatably receiving the spool assembly.

22. The line-transferring kit of claim 19 wherein the first and second anchor-enabling portions are each substantially planar and plastically angled relative to one another, the spool-extending portion and the first and second anchor-enabling portions having a relaxed Z-shaped plane configuration, the relaxed Z-shaped plane configuration being elastically deformable into a stressed Z-shaped plane configuration, the stressed Z-shaped plane configuration for enhancing cooperative association with the external anchoring means.

23. The line-transferring kit of claim 19 comprising line-guiding means, the line-guiding means being cooperable with the spool support for limiting the radial distance of line transferable from the spool assembly.
